(19) United States
(12) Patent Application Publication
(10) Pub. No.: US 2020/0083979 A1
(43) Pub. Date: Mar. 12, 2020

(54) UNMANNED AERIAL VEHICLE JAMMER

(71) Applicant: Airspace Systems, Inc., San Leandro, CA (US)

(72) Inventors: Michael Roberts, Alameda, CA (US); Brendan Olsen, San Francisco, CA (US); Tyson Messori, Alameda, CA (US); Guy Bar-Nahum, Sausalito, CA (US)

(21) Appl. No.: 16/123,963

(22) Filed: Sep. 6, 2018

(51) Int. Cl. H04K 3/00; B64C 39/02; B64D 3/02; B64D 47/08

(52) U.S. Cl. CPC H04K 3/90; B64C 39/024; B64C 2201/12; B64D 47/08; B64C 2201/027; B64D 3/02

(57) ABSTRACT

An aerial vehicle system is comprised of a detector, a signal generator, and a transmitter. The detector is configured to detect a presence of a target unmanned aerial vehicle within a range of the aerial vehicle system. The signal generator is configured to generate a communication disruption signal. The transmitter is configured to trigger a transmission of the communication disruption signal based in part on the detected presence of the target unmanned aerial vehicle.

### BACKGROUND OF THE INVENTION

Unmanned Aerial Platforms, including Unmanned Aerial Vehicles (UAV) and Aerial Drones, may be used for a variety of applications. However, some applications may pose a risk to people or property. UAVs have been used to carry contraband, including drugs, weapons, and counterfeit goods across international borders. It is further possible that UAVs may be used for voyeuristic or industrial surveillance, to commit terrorist acts such as spreading toxins, or to transport an explosive device. In view of this risk posed by malicious UAVs, it may be necessary to have a system to intercept, capture, and transport away a UAV that has entered a restricted area.

### BRIEF DESCRIPTION OF THE DRAWINGS

Various embodiments of the invention are disclosed in the following detailed description and the accompanying drawings.

FIG. 1 is a block diagram illustrating an embodiment of an unmanned aerial vehicle.

FIG. 2 is a block diagram illustrating an embodiment of a jammer system.

FIG. 3 is a flow chart illustrating an embodiment of a process for capturing a target object.

FIG. 4 is a flow chart illustrating an embodiment of a process for capturing a target object.

FIG. 5A is a diagram illustrating a front view of an unmanned aerial vehicle in accordance with some embodiments.

FIG. 5B is a diagram illustrating a side view of an unmanned aerial vehicle in accordance with some embodiments.

FIG. 6A is a diagram illustrating an embodiment of a tether mechanism.

FIG. 6B is a diagram illustrating an embodiment of a tether mechanism.

FIG. 6C is a diagram illustrating an embodiment of a tether mechanism.

FIG. 7 is a flow chart illustrating an embodiment of a process for capturing a target object.

FIG. 8 is a flow chart illustrating an embodiment of a process for determining that a target object has been captured.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An unmanned aerial vehicle (UAV) is an aircraft without a human pilot aboard the vehicle. The UAV may be remotely controlled by a human operator. UAVs are typically used to perform various tasks, such as surveillance, aerial photography, product deliveries, racing, etc. UAVs have become ubiquitous. Unintended uses for UAVs have emerged. For example, UAVs have been used to carry contraband, including drugs, weapons, and counterfeit goods across international borders. It is further possible that UAVs may be used for voyeuristic or industrial surveillance, to commit terrorist acts such as spreading toxins, or to transport an explosive device. Conventional techniques to disable a UAV include shooting down the UAV from the ground. However, such a technique risks bodily harm and/or property damage when the UAV crashes.

One approach to disable a UAV is to jam, block, or interfere with the communications system of the UAV so that the UAV is unable to communicate with a remote operator. This may prevent the remote operator from controlling the UAV to arrive at its intended destination. In-flight, the UAV may be in communication with one or more remote computing devices associated with a remote operator. In some instances, in the event the UAV loses communication with the one or more remote computing devices associated with the remote operator, the UAV may be configured to implement a communication failure procedure and return to a specific location. For example, the UAV may be configured to return to a home location, e.g., a location specified by a user of the UAV. While this may prevent the UAV from performing its intended task, the UAV may still be used at a later time to carry out its intended task.

A UAV may be disabled and/or captured by another UAV. A defending UAV may include a detector to determine that a flying object is a UAV, a jamming system to disable a target UAV, and an interdiction system to automatically capture the target UAV when the target UAV is disabled.

The detector system may include a radar system and/or a visual detection system to detect a UAV. Radar systems typically detect objects by sending out a transmission signal and if there is an object, the object will reflect a portion of the transmission signal. The radar system may receive the reflected signal and may determine a range of the detected object based on the transmission and reflection signals. The received reflection signals may also be used to determine an azimuth angle and elevation angle of the detected object.

A reflection signal may be used to determine a range of an object. The range is the distance between an antenna element of the radar system and the object. The range may be determined based of a time of flight needed to transmit a signal to the object and to receive a reflection signal. The range may also be determined by comparing a frequency of the transmitted signal with the frequency of the reflection signal.

The received signals may be used to determine a velocity of an object. The velocity of the object may be determined based on a Doppler shift of the reflected signal with respect to the transmitted signal. A Doppler shift occurs when the source of waves is moving with respect to an observer. For example, when a radar wave is incident on a moving target, the moving target may reflect the radar wave and cause a Doppler shift in the reflection wave.

The frequency of the reflected wave f may be determined by calculating:

$$f = ( \frac{c \pm {v}_{r}}{c \pm {v}_{s}} )$$

f₀ where f₀ is the frequency of the transmitted wave, c is the velocity of the waves in the medium, vᵣ is the velocity of the receiver relative to the medium; positive if the receiver is moving towards the source (and negative in the other direction), and vₛ is the velocity of the source relative to the medium; positive if the source is moving away from the receiver (and negative in the other direction.

An object may produce a plurality of reflection signals. A transmission signal may be transmitted toward an object and reflect off different components of the object. The reflection signals off the different components may be combined and received at an antenna element. The object may also include a plurality of components moving at different velocities. For example, a transmission signal may be transmitted towards a car. The transmission signal may be reflected by the body of the car and the wheels of the car. The velocity of the body of the car and the wheels of the car is different. A transmission signal may be transmitted towards a UAV. The transmission signal may be reflected by the body of the UAV and each rotor of the UAV. A velocity of the body of the UAV is different than the velocity of the rotors. A velocity of each rotor may also be different.

Visual detection systems may analyze an image obtained by one or more cameras to determine whether the image data includes a UAV.

A machine learning model may be trained to determine whether the object is a UAV or not a UAV. In some embodiments, a machine learning model is configured to determine that the object is a UAV based on image data associated with a detected object. In other embodiments, a machine learning model is configured to determine that the object is a UAV based on a feature vector associated with the object. The feature vector may include values associated with a velocity of the detected object. In the event the machine learning model outputs a value that labels the object as a UAV, the defending UAV may be configured to perform an action, such as activating an interdiction system to capture the object and/or triggering a transmission of a communication disruption signal (e.g., jammer signal). In some embodiments, a radar system and visual detection system may both confirm that a UAV has been detected.

When the detected object is identified as a UAV, the jamming system may be configured to temporarily disrupt the communications system of the target UAV, such that the flying pattern of the target UAV is modified and the target UAV does not initiate its communication failure procedure. Communication disruption signals typically operate in a frequency range associated with a plurality of wireless communication devices (e.g., cell phones). When a communication disruption signal is transmitted, it may not only disrupt the communication system of the target UAV, but also disrupt the communication systems of one or more other wireless communication devices in the path of the communication disruption signal. It is important is accurately detect a UAV to prevent erroneous use of the communication disruption signal and to minimize any potential downtime of other communication devices as a result of the communication disruption signal being transmitted.

The communications system of a UAV may be disrupted by jamming either the communications system of a target UAV or the communications system associated with a remote operator. A defending UAV may be able to get closer to the target UAV than the remote operator. As a result, less jamming power is required to disrupt the communications system of the UAV. This reduces the impact that the communications disruption signal may have on other nearby devices.

The jamming system may be configured to temporarily disrupt the communication system of the target UAV by generating and transmitting a communication disruption signal that is based on a sawtooth wave. A sawtooth wave is a non-sinusoidal wave with sharp ramps going upwards and then suddenly downwards or a non-sinusoidal wave with sharp ramps going downwards and then suddenly upwards. The power of a communication disruption signal at the peak of the sawtooth wave may be sufficient to jam the communications system of the target UAV, but due to the nature of the sawtooth wave, the communications system of the target UAV may be temporarily disabled because the power of the communication disruption signal will suddenly drop and ramp up again. As a result, the one or more processors of the target UAV may not realize it is under attack and not commence its communications failure procedure. The communication disruption signal may be turned on and off in a pulse wave manner. The communication disruption signal may be transmitted for one or more cycles and then turned off after a couple of cycles.

When the communications system of the target UAV is working properly, a flight pattern of the target UAV is unrestricted. The flight pattern may be controlled by a remote user and/or on-board computers. When the UAV receives a communication disruption signal that is based on a sawtooth wave, the communications system of the target UAV may become temporarily disabled, which may restrict the flight pattern of the target UAV such that the target UAV hovers over its current location. The target UAV may continue flying in a hovering pattern until communications is reestablished with a remote location. When communications is reestablished, the target UAV may continue its previous flight pattern.

A defending UAV may detect that the target UAV is flying in a hovering pattern. For example, the defending UAV may include a visual detection system to detect a flight pattern of an object. The visual detection system may be configured to determine that the flight pattern of the object is unrestrained or that the flight pattern of the object is restrained (e.g., hovering pattern). Upon detecting a restrained flight pattern, the defending UAV may be configured to activate an interdiction system. The interdiction system may be comprised of a capture net launcher, an interdiction sensor package, an interdiction control system, and a tether mechanism. Activating the interdiction system may cause the interdiction control system to send a signal to the capture net launcher, which launches a capture mechanism, such as a net, in the direction of the target UAV. When the capture mechanism is launched and captures a target UAV, the target UAV may remain tethered to the defending UAV via a tether (e.g., rope, cable, etc.). This enables the defending UAV to transport the target UAV to a safe location. Accurately identifying and locating a target UAV is important because the number of capture mechanisms associated with the capture net launcher may be limited and finite due to the size of the defending UAV. Accidentally deploying the capture net launcher to capture an object that is not a UAV (e.g., bird, balloon) reduces the number of capture mechanisms that may be used to capture actual target UAVs.

When it is determined that the target UAV has been captured, the defending UAV may stop transmitting the communication disruption signal. One problem with communication disruption signals is that they operate in a frequency range associated with a plurality of wireless communication devices (e.g., cell phones). While the directionality of the communication disruption signal may be adjusted, any wireless communications device in the direction of the communication disruption signal that operates in the frequency range of the communication disruption signal will also be jammed. The defending UAV may include a tether mechanism that indicates when the target UAV has been captured. In response to the tether mechanism indicating the target UAV has been captured, the defending UAV may be configured to stop transmitting the communication disruption signal. This may minimize the amount of time the other wireless communication devices are also jammed. In other embodiments, the defending UAV stops transmitting the communication disruption signal after the capture mechanism is activated.

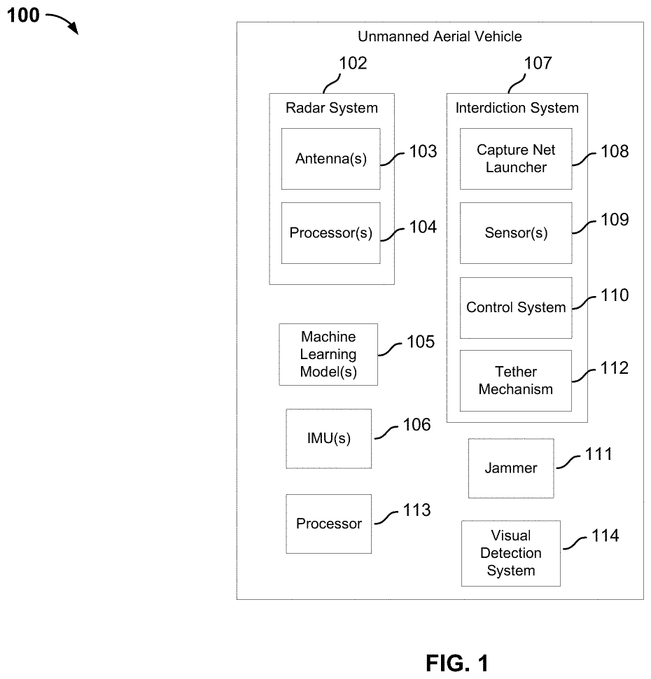

FIG. 1 is a block diagram illustrating an embodiment of an unmanned aerial vehicle. Unmanned aerial vehicle 100 is comprised of a radar system 102, one or more machine learning models 105, one or more inertial measurement units 106, an interdiction system 107, a jammer 111, a processor 113, and a visual detection system 114.

Radar system 102 is comprised of one or more antennas 103 and one or more processors 104. The one or more antennas 103 may be a phased array, a parabolic reflector, a slotted waveguide, or any other type of antenna design used for radar. The one or more processors 104 are configured to excite a transmission signal for the one or more antennas 103. The transmission signal has a frequency f₀. Depending on the antenna design, the transmission signal may have a frequency between 3 MHz to 110 GHz. In response to the excitation signal, the one or more antennas 103 are configured to transmit the signal. The transmission signal may propagate through space and reflect off one or more objects. The reflection signal may be received by the one or more antennas 103. In some embodiments, the reflection signal is received by a subset of the one or more antennas 103. In other embodiments, the reflection signal is received by all of the one or more antennas 103. The strength (amplitude) of the received signal depends on a plurality of various factors, such as a distance between the one or more antennas 103 and the reflecting object, the medium in which the signal is transmitted, the environment, the material of the reflecting object, etc. In other embodiments, no reflection signal is received by the one or more antennas 103. This indicates that an object was not detected.

The one or more processors 104 are configured to receive the reflection signal from the one or more antennas 103. The one or more processors 104 are configured to determine a velocity of the detected object based on the transmission signal and the reflection signal. The velocity may be determined by computing the Doppler shift. A detected object may have one or more associated velocities. An object without any moving parts, such as a balloon, may be associated with a single velocity. An object with moving parts, such as a car, helicopter, UAV, plane, etc., may be associated with more than one velocity. The main body of the object may have an associated velocity. The moving parts of the object may each have an associated velocity. For example, a UAV is comprised of a body portion and a plurality of rotors. The body portion of the UAV may be associated with a first velocity. Each of the rotors may be associated with corresponding velocities.

In some embodiments, the one or more antennas 103 is a phased antenna array. In the event the one or more antennas 103 detect an object, a beam associated with the phase antenna array may be directed towards the object. To change the directionality of the antenna array when transmitting, a beam former (e.g., the one or more processors 104) may control the phase and relative amplitude of the signal at each transmitting antenna of the antenna array, in order to create a pattern of constructive and destructive interference in the wave front.

Radar system 102 is coupled to the one or more inertial measurement units 106. The one or more inertial measurement units 106 are configured to calculate attitude, angular rates, linear velocity, and/or a position relative to a global reference frame. The one or more processors 104 may use the measurements from the one or more IMUs 106 to determine an EGO motion of the UAV 100. The one or more processors 104 may also use one or more extended Kalman filters to smooth the measurements from the one or more inertial measurement units 106. One or more computer vision-based algorithms (e.g., optical flow) may be used to determine the EGO motion of UAV 100. The one or more processors 104 may be configured to remove the EGO motion data of UAV 100 from the reflection signal data to determine one or more velocities associated with a detected object. From UAV 100's perspective, every detected item appears to be moving when UAV 100 is flying. Removing the EGO motion data from the velocity determination allows radar system 102 to determine which detected objects are static and/or which detected objects are moving. The one or more determined velocities may be used to determine a micro-Doppler signature of an object.

The one or more processors 104 may generate a velocity profile from the reflected signal to determine a micro-Doppler signature associated with the detected object. The velocity profile compares a velocity of the reflection signal(s) with an amplitude (strength) of the reflection signal(s). The velocity axis of the velocity profile is comprised of a plurality of bins. A velocity of the reflection signal with the highest amplitude may be identified as a reference velocity and the amplitude associated with the reference velocity may be associated with a reference bin (e.g., bin B₀). The one or more other velocities included in the reflection signal may be compared with respect to the reference velocity. Each bin of the velocity profile represents an offset with respect to the reference velocity. A corresponding bin for the one or more other velocities included in the reflection signal may be determined. A determined bin includes an amplitude associated with one of the one or more other velocities included in the reflection signal. For example, a reflection signal may be a reflection signal associated with a UAV. The UAV is comprised of a main body and a plurality of rotors. The velocity of a UAV body may be represented as a reference velocity in the velocity profile. The velocity of a UAV rotor may be represented in a bin offset from the reference velocity. The bin associated with the reference velocity (e.g., B₀) may store an amplitude associated with the velocity of the UAV body. The bin offset from the reference bin (e.g., ±B₁, ±B₂ . . . ±Bₙ) may store an amplitude associated the velocity of a UAV rotor.

A direction of a beam of the phased antenna array may be focused towards a detected object such that a plurality of antenna elements 103 receive a reflection signal from the detected object. A velocity profile for each of the received corresponding reflection signals may be generated. The velocity profile for each of the received corresponding reflection signals may be combined. The combined velocity profile includes the same bins as one of the velocity profiles, but a bin of the combined velocity profile stores a plurality of amplitudes from the plurality of velocity profiles. A maximum amplitude value (peak) may be selected for each bin of the combined velocity profile. The maximum amplitude bin values may be used in a feature vector to classify the object. For example, the feature vector may include the values {B₀ₘₐₓ, B₁ₘₐₓ, . . . , Bₙₘₐₓ}.

Radar system 102 is coupled to processor 113. Radar system 102 may provide the feature vector to processor 113 and the processor 113 may apply the feature vector to one of the machine learning models 105 that is trained to determine whether the object is a UAV or not a UAV. The one or more machine learning models 105 may be trained to label one or more objects. For example, a machine learning model may be trained to label an object as a “UAV” or “not a UAV.” A machine learning model may be trained to label an object as a “bird” or “not a bird.” A machine learning model may be trained to label an object as a “balloon” or “not a balloon.”

The one or more machine learning models 105 may be configured to implement one or more machine learning algorithms (e.g., support vector machine, soft max classifier, autoencoders, naïve bayes, logistic regression, decision trees, random forest, neural network, deep learning, nearest neighbor, etc.). The one or more machine learning models 105 may be trained using a set of training data. The set of training data includes a set of positive examples and a set of negative examples. For example, the set of positive examples may include a plurality of feature vectors that indicate the detected object is a UAV. The set of negative examples may include a plurality of feature vectors that indicate the detected object is not a UAV. For example, the set of negative examples may include feature vectors associated with a balloon, bird, plane, helicopter, etc.

In some embodiments, the output of machine learning model trained to identify UAVs may be provided to one or more other machine learning model that are trained to identify specific UAV models. The velocity profile of a UAV may follow a general micro-Doppler signature, but within the general micro-Doppler signature, different types of UAVs may be associated with different micro-Doppler signatures. For example, the offset difference between a bin corresponding to a baseline velocity and a bin corresponding to a secondary velocity may have a first value for a first UAV and a second value for a second UAV.

The output from the one or more machine learning models 105 may be provided to jammer 111. Jammer 111 may include one or more antennas to transmit a communication disruption signal. For example, a directional antenna (e.g., log periodic antenna) may be used to transmit the communication disruption signal. The communication disruption signal may be configured to disrupt signals at 2.1 GHz and 5.8 GHz. In some embodiments, a dual frequency antenna is used to disrupt both signals. In other embodiments, a first antenna is used to disrupt signals at 2.1 GHz and a second antenna is used to jam signals at 5.8 GHz. Jammer 111 may include a microcontroller. The microcontroller may be configured to receive the output from the one or more machine learning models 105. In response to one of the one or more machine learning models identifying a UAV, the microcontroller may be configured to send a control signal that causes jammer 111 to send a communication disruption signal in the direction of the identified UAV. The jamming system may be configured to temporarily disrupt the communication system of the target UAV through the use of a communication disruption signal that is based on a sawtooth wave. A sawtooth wave is a non-sinusoidal wave with sharp ramps going upwards and then suddenly downwards or a non-sinusoidal wave with sharp ramps going downwards and then suddenly upwards. The power of a communication disruption signal at the peak of the sawtooth wave may be sufficient to jam the communications system of the target UAV, but due to the nature of the sawtooth wave, the communications system of the target UAV may be temporarily disabled because the power of the communication disruption signal will suddenly drop and ramp up again. The power of the communication disruption signal may be based on a type of the target UAV. For example, the communication disruption signal may have a first power for a first type of UAV and a second power for a second type of UAV. A set of predefined jamming conditions may have to be met before jammer 111 is configured to transmit the communication disruption signal. The predefined jamming conditions may include an identification of a target UAV and a threshold range between the target UAV and UAV 100. In other embodiments, jammer 111 is a software defined radio and may be configured to jam signals in a frequency range of 400 MHz and 10 GHz.

Interdiction system 107 may receive an indication from jammer 111 that indicates a communication disruption signal is being transmitted. Interdiction system 107 may include a capture net launcher 108, one or more sensors 109, a control system 110, and a tether mechanism 112. A loop of a net may be coupled to a tether mechanism. The tether mechanism 112 may be used to restrain a net on the UAV until the net is deployed. The tether mechanism 112 may include a locking mechanism holds a net in place. A deployed net may be coupled to UAV 100 via a tether (e.g., cable, rope, etc.)

In response to the indication, control system 110 may be configured to monitor signals received from the one or more sensors 109 and/or radar system 102, and control capture net launcher 108 to automatically deploy the capture net when predefined firing conditions are met. One of the predefined firing conditions may include an identification of a target UAV. One of the predefined firing conditions may include a threshold range between the target UAV and UAV 100. One of the predefined firing conditions may include a flight pattern associated with a target UAV. For example, a detected object may be required to be identified as a UAV and identified UAV may be required to be flying in a hovering flight pattern within a threshold distance before the net may be fired. In some embodiments, after a capture net is deployed, control system 110 provides to jammer 111 a control signal that causes jammer 111 to stop a transmission of the communications disruption signal.

The one or more sensors 109 may include a global positioning system, a light detection and ranging (LIDAR) system, a sounded navigation and ranging (SONAR) system, an image detection system (e.g., photo capture, video capture, UV capture, IR capture, etc.), sound detectors, one or more rangefinders, etc. The one or more sensors 109 and/or the visual detection system 114 may sense a flight pattern associated with a target UAV. In the event the one or more sensors 109 and/or the visual detection system 114 detect the target UAV is flying in a hovering flight pattern, the control system 110 may provide a control signal to tether mechanism 112 to release the locking mechanism and a control signal to capture net launcher 108 to fire the net.

When the interdiction control system 110 determines that the object is a target UAV, it may also determine if the target UAV is an optimal capture position relative to the defending UAV. If the relative position between the target UAV and the defending UAV is not optimal, interdiction control system 110 may provide a recommendation or indication to the remote controller of the UAV. Interdiction control system 1110 may provide or suggest course corrections directly to the processor 111 to maneuver the UAV into an ideal interception position autonomously or semi-autonomously. Once the ideal relative position between the target UAV and the defending UAV is achieved, interdiction control system 110 may automatically trigger capture net launcher 108. Once triggered, capture net launcher 108 may fire a net designed to ensnare the target UAV and disable its further flight.

In the event the one or more sensors 109 and/or the visual detection system 114 detect that the target UAV is not flying in a hovering flight pattern after a communication disruption signal is transmitted, the control system 110 may provide a control signal to jammer 111. In response to the control signal from the control system 110, jammer 111 may be configured to increase a power of the communication disruption signal.

The net fired by the capture net launcher may be tethered to UAV 100 via a tether (e.g., cable, rope, etc.). This may allow UAV 100 to move the target UAV to a safe area for further investigation and/or neutralization. Tether mechanism 112 may include a motor that causes a locking mechanism to move. The motor may use a particular amount of current to displace the locking mechanism so that a net may be deployed. The tether mechanism 112 may be configured to keep the locking mechanism in a particular position (e.g., a neutral position) after a net is deployed. The motor may use a particular amount of current to keep the locking mechanism in the particular position. The motor may provide a current signal to control system 110. The current signal profile of the motor may change after the net is deployed. For example, more current may be used by the motor to keep the locking mechanism in the particular position if the net captured a UAV than if the net did not capture a UAV. This current signal profile may be used by control system 110 to determine that the target UAV is captured. This current signal may also be used by control system 110 to sense the weight, mass, or inertia effect of a target UAV being tethered in the capture net and recommend action to prevent the tethered target UAV from causing UAV 100 to crash or lose maneuverability. For example, control system 110 may recommend UAV 100 to land, release the tether, or increase thrust.

When it is determined that the target UAV has been captured, the defending UAV may stop transmitting the communication disruption signal. One problem with communication disruption signals is that they operate in a frequency range associated with a plurality of wireless communication devices. While the directionality of the communication disruption signal may be adjusted, any wireless communications device in the direction of the communication disruption signal that operates in the frequency range of the communication disruption signal will also be jammed. In response to tether mechanism 112 indicating that the target UAV has been captured, jammer 111 may be configured to stop transmitting the communication disruption signal.

In other embodiments, the net is coupled to a pressure sensor. When the net has captured a UAV, the pressure sensor will have a first measurement. When the net has not captured a UAV, the pressure sensor will have a second measurement. The pressure sensor signals may be provided to control system 110, which may use signals to determine whether the target UAV is captured.

Unmanned Aerial Vehicle 100 may include a visual detection system 114. Visual detection system 114 may be comprised of one or more cameras and be used to visually detect a UAV. Visual detection system 114 may visually detect an object and provide image data (e.g., pixel data) to one of the one or more machine learning models 105. A machine learning model may be trained to label an object as “a UAV” or “not a UAV” based on the image data. For example, a set of positive examples (e.g., images of UAVs) and a set of negative examples (e.g., images of other objects) may be used to train the machine learning model. Visual detection system 114 may be configured to determine that the flight pattern of the object is unrestrained or that the flight pattern of the object is restrained (e.g., hovering pattern).

Processor 113 may use the output from the machine learning model trained to label an object as a UAV based on the radar data and the machine learning model trained to label the object as a UAV based on image data to determine whether to activate the interdiction system 107. Processor 113 may activate interdiction system 107 in the event the machine learning model trained to label an object as a UAV based on radar data and the machine learning model trained to label the object as a UAV based on image data both indicate that the object is a UAV.

UAV 100 may use radar system 102 to detect an object that is greater than a threshold distance away. UAV 100 may use camera system 114 to detect an object that is less than or equal to the threshold distance away. UAV 100 may use both radar system 102 and camera system 114 to confirm that a detected object is actually a UAV. This reduces the number of false positives and ensures that the capture active mechanism is activated for actual UAVs.

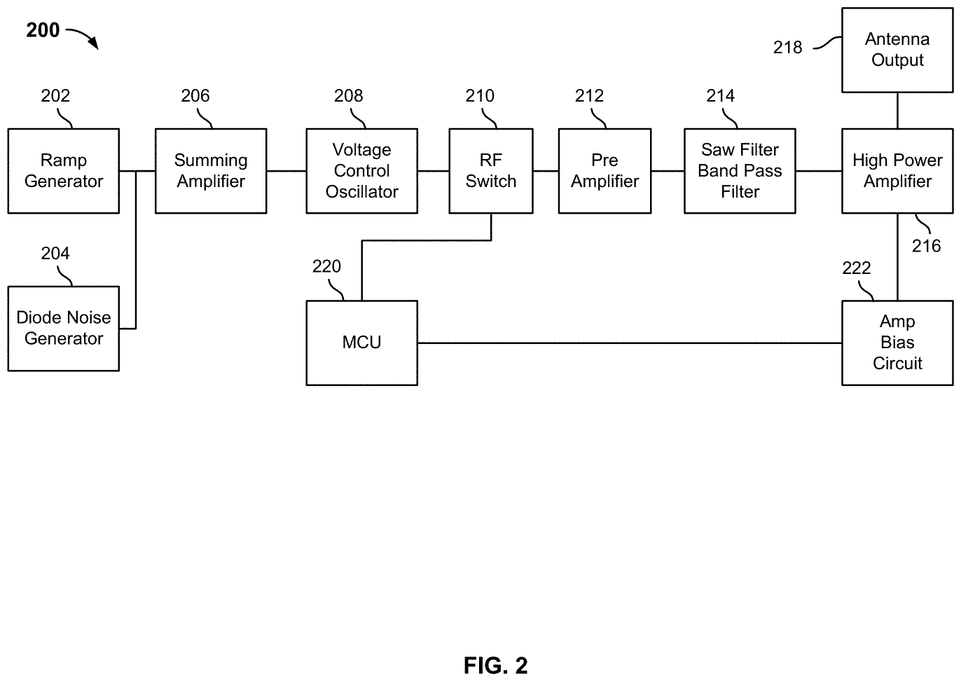

FIG. 2 is a block diagram illustrating an embodiment of a jammer system. In the example shown, jammer system 200 may be implemented by an unmanned aerial vehicle, such as unmanned aerial vehicle 100.

In the example shown, jammer system 200 includes a ramp generator 202, a diode noise generator 204, a summing amplifier 206, a voltage control oscillator 208, a RF switch 210, a preamplifier 212, a saw filter band pass filter 214, a high power amplifier 216, an antenna output 218, a microcontroller unit 220, and an amplifier bias circuit 222.

Ramp generator 202 is configured to generate an electric signal that increases its output voltage to a specific value. The output of ramp generator 202 may be a sawtooth wave. The sawtooth wave is used as a communication disruption signal to confuse and disorient a target object, such as a UAV. The purpose of a communication disruption signal is to block or interfere with the wireless communications of the target object. In response to a communications error, some UAVs are configured to implement a communications failure procedure and return to a start location, which may be determined from a GPS of the UAV. A sawtooth wave may confuse the communications system of the target object such that the target object hovers around its current position.

Diode noise generator 204 is configured to generate electrical noise (i.e., a random signal.) Summing amplifier 206 is coupled to ramp generator 202 and diode noise generator 204 and configured to sum the output voltage of ramp generator 202 and the output voltage of diode noise generator 204 into a single output voltage.

Summing amplifier 206 is coupled to voltage control oscillator 208. The oscillation frequency of voltage control oscillator 208 is controlled by the voltage output of summing amplifier 206. Voltage control oscillator 208 is coupled to RF switch 210. When RF switch 210 is in an open position, no communication disruption signal is outputted by system 200. When RF switch 210 is in a closed position, system 200 outputs a communication disruption signal. RF switch 210 may be configured to open or close based on a control signal from the microcontroller unit 220.

RF switch 210 is coupled to pre amplifier 212. In the event RF switch 210 is in a closed position, its output is provided to pre amplifier 212. Pre amplifier 212 is configured to amplify the output of RF switch 210. Pre amplifier 212 is coupled to Saw Filter Band Pass Filter 214. Saw Filter Band Pass Filter 214 is configured to convert the electrical output signal of pre amplifier 212 into an acoustic wave. Saw Filter Band Pass Filter 214 may filter out signals that are outside the frequency range of 2.1-5.8 GHz and pass signals that are within the frequency range of 2.1-5.8 GHz. This may prevent the communication signal from disrupting the computing components of the defending UAV. The output of saw filter band pass filter 214 is coupled to high power amplifier 216. In some embodiments, high power amplifier 216 is configured to amplify the output of saw filter band pass filter 214 by a first power ratio or a second power ratio based on a distance between defending UAV and target UAV. For example, in the event the distance is less than a first threshold, the communication disruption signal may have a first power. In the event the distance is greater than or equal to the first threshold, the communication disruption signal may have a second power where the second power is greater than the first power. High power amplifier 216 is coupled to an antenna output 218. The output of antenna output 218 may be directed to a target object, such as a target UAV. In some embodiments, the antenna of antenna output 218 is a parabolic directional antenna. The antenna may be configured to operate at dual frequencies, such as 2.1 GHz and 5.8 GHz. Amp bias circuit 212 is coupled to high power amplifier 216. Amp bias circuit 212 is configured to slowly bias high power amplifier 216. Amp bias circuit 212 enables the high power amplifier 216 to be used on demand without having to wait for the high power amplifier to start up.

Microcontroller unit 220 is coupled to RF switch 210 and Amp bias circuit 222. Microcontroller 220 is coupled to one or more other processing components of a UAV (not shown). Microcontroller 220 may receive one or more signals from the one or more other processing components to determine when to send a signal to close RF switch. For example, microcontroller unit 220 may receive a signal that indicates a target object is within a particular range (e.g., 50 m). In response to the signal, microcontroller unit 220 may be configured to send a signal to RF switch 210 to close the switch. Microcontroller unit 220 may be configured to open and close the switch in a pulse pattern. Certain components of system 200 have a tendency to heat up during operation. Microcontroller unit 220 may be configured to send a signal to RF switch 210 to open the switch such that some of the components of system 200 do not overheat. When the communication disruption signal is transmitted from system 200, not only is the communications of a target object interrupted, but the communications systems of other neighboring electronic devices may also be interrupted. To minimize the amount of interruption, microcontroller unit 220 may be configured to send an open signal to RF switch 210.

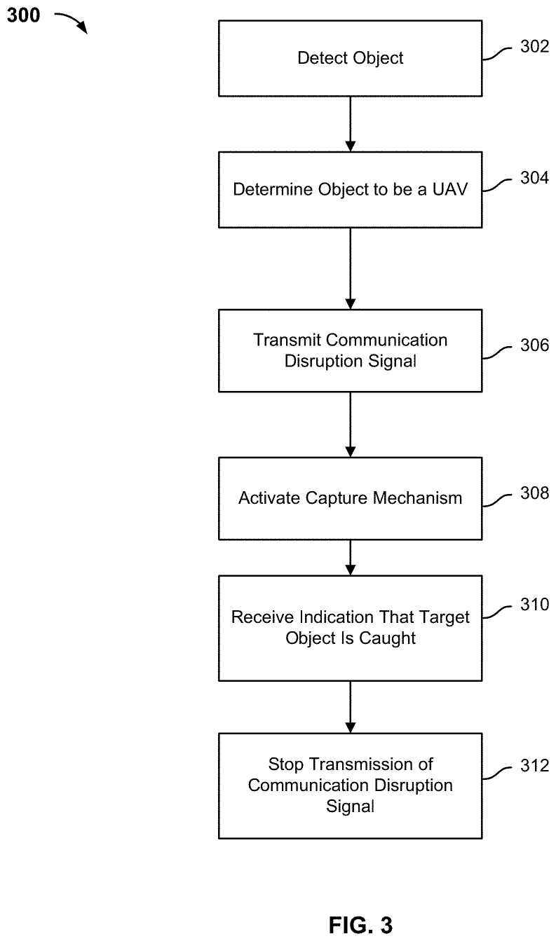

FIG. 3 is a flow chart illustrating an embodiment of a process for capturing a target object. In the example shown, process 300 may be performed by a UAV, such as UAV 100.

At 302, an object is detected. The object may detected using one or more of a radar system, a light detection and ranging (LIDAR) system, a sounded navigation and ranging (SONAR) system, a visual detection system (e.g., photo capture, video capture, UV capture, IR capture, etc.), sound detectors, one or more rangefinders, etc.

At 304, the detected object is determined to be a UAV. The detected object may be determined to be a UAV based on image data associated with a visual detection system. For example, image data (e.g. pixels) may be provided to a machine learning model that is trained to output a label based on the image data. A machine learning model may be trained output a label of “UAV” or “not a UAV.” The machine learning model may be trained using a set of positive examples and a set of negative examples. The set of positive examples may include image data associated with a UAV, e.g., images of UAVs. The set of negative examples may include image data associated with objects that are not a UAV (e.g., bird, airplane, balloon, person, etc.) The machine learning model may be trained to output a label of “UAV” in the event the image data of the detected object is similar to the set of positive examples.

In other embodiments, the detected object may be determined to be a UAV based on a micro-Doppler signature associated with the detected object. A radar system may receive one or more reflections from the detected object. A detected object may be comprised of a plurality of components. The plurality of components may have different velocities. For example, a radar system may transmit a transmission signal towards a car. The transmission signal may be reflected off the body of the car as well as the wheels of the car. A velocity of the body of the car may be different than a velocity of a wheel when the car is moving. A radar system may transmit a transmission signal towards a UAV. The transmission signal may reflect off the body of the UAV as well as each of the rotors of the UAV. A velocity of the body of the UAV may be different than a velocity of each of the rotors. The velocities of the different components may be determined based on the one or more reflected signals. An object may be determined based on the relative velocities of the different components. For example, the velocity associated with a body of a car may have a particular velocity offset from the wheels of the car. The velocity associated with a body of a UAV may have a particular velocity offset from the rotors of the UAV. The velocity profile of different objects may represent a micro-Doppler signature of an object and used to determine a detected object to be a UAV.

At 306, a communication disruption signal is transmitted. A power of the communication disruption signal may be based on a distance between a target UAV and a defending UAV. In the event the distance is less than a first threshold, the communication disruption signal may have a first power. In the event the distance is greater than or equal to the first threshold, the communication disruption signal may have a second power.

The communication disruption signal may be based on a sawtooth wave. The communication disruption signal is configured to confuse the target UAV such that the target UAV hovers over a particular area instead of freely flying around. The communication disruption signal is configured to block or interfere with the wireless communications of the target UAV. Some UAVs are configured to return to a start position in the event its wireless communication system is are blocked and/or interfered. The communication disruption signal is configured such that the wireless communication systems of the target UAV is temporarily blocked and/or interfered, but then return back to normal temporarily, and temporarily blocked and/or interfered, and then again return back to normal temporarily, and so forth. The communication disruption signal prevents the target UAV from determining that its communication systems is blocked and/or interfered because the duration in which the communications systems is blocked and/or interfered is less than the duration that causes the target UAV to implement its communication failure procedure (e.g., return back to the start position).

The communication disruption signal may be transmitted in the event a set of predetermined conditions are satisfied. The set of predetermined conditions may include a detected object being determined to be a UAV and the UAV being within a threshold range. In the event the set of predetermined conditions are satisfied, a microcontroller of the communication disruption signal generator may provide a control signal that closes a switch such that the communication disruption signal is transmitted.

Different models of target UAV may have different communication failure procedures. For example, a first UAV may implement a communication failure procedure after communications are disabled for a threshold period of time (e.g., five seconds). A second UAV may implement a communication failure procedure that tries to re-establish communication for a threshold number of times. In the event communication cannot be re-established after the threshold number of times, the second UAV may be configured to implement the communication failure procedure. The waveform of the communication disruption signal may be adjusted based on the particular type of target UAV. For example, the ramp time of the communication disruption signal may be increased/decreased based on the type of the target UAV. The strength of the communication disruption signal may also be increased/decreased based on the particular type of target UAV. The frequency of the communication disruption signal may be modified to the particular type of target UAV.

At 308, a capture mechanism is activated. The capture mechanism of UAV may include an interdiction system that enables the UAV to capture, disable, and/or transport a target UAV away from a particular area. The interdiction system may be comprised of a capture net launcher, an interdiction sensor package, and an interdiction control system. The interdiction control system may monitor signals received from the interdiction sensor package and control the capture net launcher to automatically deploy the capture net when one or more predefined conditions are met. The one or more predefined conditions may include a target UAV is detected, the target UAV is within a threshold distance, and the target UAV is currently hovering over a particular area because the communications system of the target UAV is blocked and/or interfered.

The interdiction sensor module may include range finding sensors, such as RADAR rangefinders, LIDAR rangefinders, SONAR based rangefinders, ultrasonic based rangefinders, stereo-metric cameras, or another other range finding sensor.

At 310, an indication that the target object is caught is received. The net fired by the capture net launcher may be tethered to a defending UAV via a tether. This may allow UAV to move the target UAV to a safe area for further investigation and/or neutralization. A tether mechanism may include a motor that causes a locking mechanism to move. The motor may use a particular amount of current to displace the locking mechanism so that the net may be deployed. The tether mechanism may be configured to keep the locking mechanism in a particular position after a net is deployed. The motor may use a particular amount of current to keep the locking mechanism in the particular position. The motor may provide a current signal to control system. The current signal profile of the motor may change after the net is deployed. For example, more current may be used by the motor to keep the locking mechanism in the particular position if the net captured a UAV than if the net did not capture a UAV. This current signal may be used by control system to determine that the target UAV is captured. This current signal may also be used by control system to sense the weight, mass, or inertia effect of a target UAV being tethered in the capture net and recommend action to prevent the tethered target UAV from causing UAV to crash or lose maneuverability. For example, control system may recommend UAV to land, release the tether, or increase thrust.

In other embodiments, the net is coupled to a pressure sensor. When the net has captured a UAV, the pressure sensor will have a first measurement. When the net has not captured a UAV, the pressure sensor will have a second measurement. The pressure sensor signals may be provided to the interdiction control system, which may use the signals to determine whether the target UAV is captured.

At 312, a transmission of the communication disruption signal is stopped. When it is determined that the target UAV has been captured, the defending UAV may stop transmitting the communication disruption signal. One problem with communication disruption signals is that they operate in a frequency range associated with a plurality of wireless communication devices (e.g., cell phones). While the directionality of the communication disruption signal may be adjusted, any wireless communications device in the direction of the communication disruption signal that operates in the frequency range of the communication disruption signal will also be jammed. In response to the tether mechanism indicating the target UAV has been captured, the defending UAV may be configured to stop transmitting the communication disruption signal. This may minimize the amount of time the other wireless communication devices are also jammed.

In some embodiments, the transmission of the communication disruption signal is stopped after the capture mechanism is activated without receiving an indication that the target object is caught (e.g., step 310 is optional).

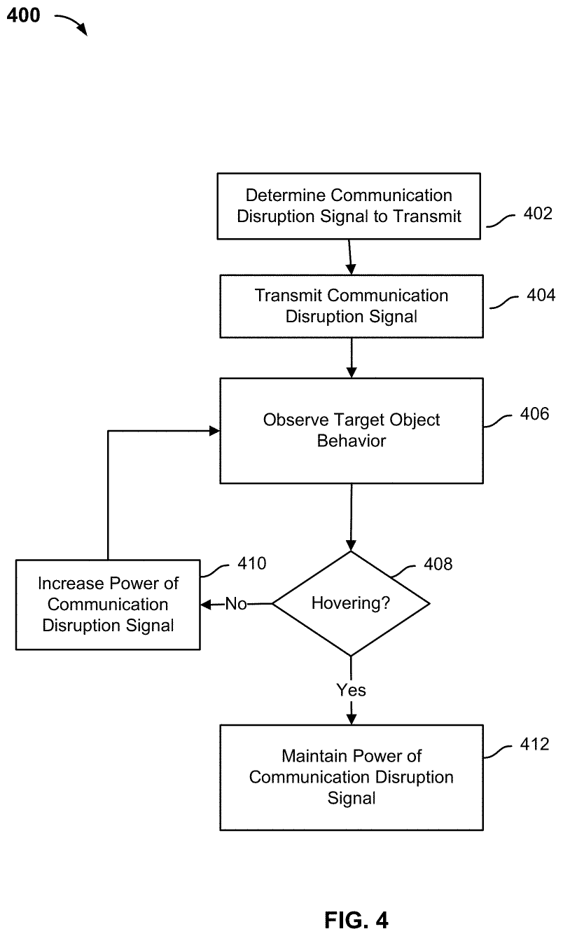

FIG. 4 is a flow chart illustrating an embodiment of a process for capturing a target object. In the example shown, process 400 may be performed by an unmanned aerial vehicle, such as unmanned aerial vehicle 100. Process 400 may be used to perform some or all of step 306.

At 402, a communication disruption signal to transmit is determined. The image data and/or micro-Doppler signature may be applied to a hierarchical classifier. A first level of the hierarchical classifier includes a machine learning model that is trained to output a label indicating whether the object is or is not a UAV. In the event the first level of the hierarchical classifier outputs a label indicating the object is a UAV, the label along with the image data and/or micro-Doppler signature may be provided to a second level of the hierarchical classifier. The second level may be comprised of a one or more machine learning models. Each machine learning model of the second level may be trained to output a label indicating whether the object is a particular type of UAV. For example, a first machine learning model of the second level may be trained to output a label indicating whether the object is or is not a first type of UAV based on the image data and/or micro-Doppler signature associated with the object. A second machine learning model of the second level may be trained to output a label indicating whether the object is or is not a second type of UAV based on the image data and/or micro-Doppler signature associated with the object.

A communication disruption signal may be tailored to the type of detected UAV. For example, the ramp time of the communication disruption signal may be increased/decreased based on the particular type of the target UAV. The strength of the communication disruption signal may also be increased/decreased based on the particular type of target UAV. The frequency of the communication disruption signal may be modified to the particular type of target UAV. The communication disruption signal may be adjusted based on a type of UAV because different types of UAVs require different communication disruption signals to interfere and/or disable their communication systems. Different types of UAVs may also have different communication failure procedures. A communication disruption signal may be tailored for a particular type of UAV so that the UAV's communication failure procedure is not initiated, but the UAV's communications system is still able to be temporarily disabled.

At 404, a communication disruption signal is transmitted. The communication disruption signal may be based on a sawtooth wave. The communication disruption signal is configured to confuse the target UAV such that the target UAV hovers over a particular area instead of freely flying around. The communication disruption signal is to configured block or interfere with the wireless communications of the target UAV. Some UAVs are configured to return to a start position in the event its wireless communication systems are blocked and/or interfered. The communication disruption signal is configured such that the wireless communication systems of the target UAV are temporarily blocked and/or interfered, but then return back to normal temporarily, and temporarily blocked and/or interfered, and then again return back to normal temporarily. The communication disruption signal prevents the target UAV from determining that its communication systems are blocked and/or interfered because the duration in which the communications systems are blocked and/or interfered is less than the duration that causes the target UAV to return back to the start position.

In some embodiments, the communication disruption signal is configured based on the type of UAV detected. For example, the power of the communication disruption signal may be configured for a specific type of UAV, that is, the power is set of a value known to disable a particular type of UAV.

At 406, a behavior of the target object is observed. When the communications system of a UAV is temporarily disabled, the UAV hovers over a particular location. When the communications system of the UAV is not temporarily disabled, the UAV is able to freely hover. A visual detection system may be configured to determine that the flight pattern of the object is unrestrained or that the flight pattern of the object is restrained (e.g., hovering pattern).

At 408, it is determined whether the target object is hovering. In the event the target object is hovering, process 400 proceeds to 412. This indicates that the communication disruption signal successfully disabled the communications system of the UAV. In the event the target object is not hovering, process 400 proceeds to 410. This may indicate that that the communication disruption signal was not powerful enough to disable the communications system of the UAV. For example, the range of the target UAV may require a higher power communication disruption signal. At 410, a power of the communication disruption signal is increased.

At 412, a power of the communication disruption signal is maintained. The power of the communication disruption signal is maintained until an indication that the target UAV is captured has been received.

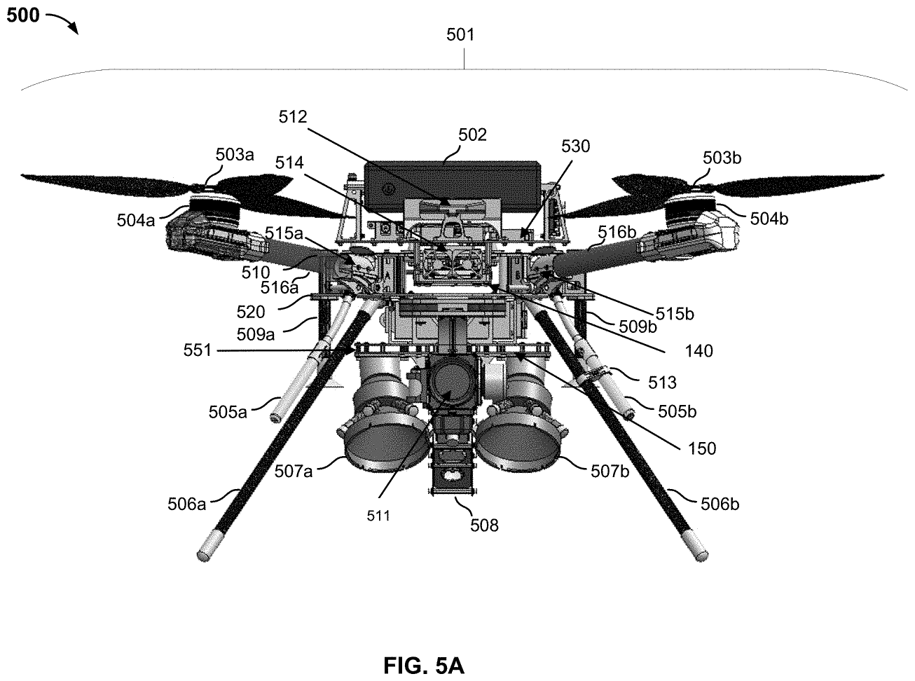

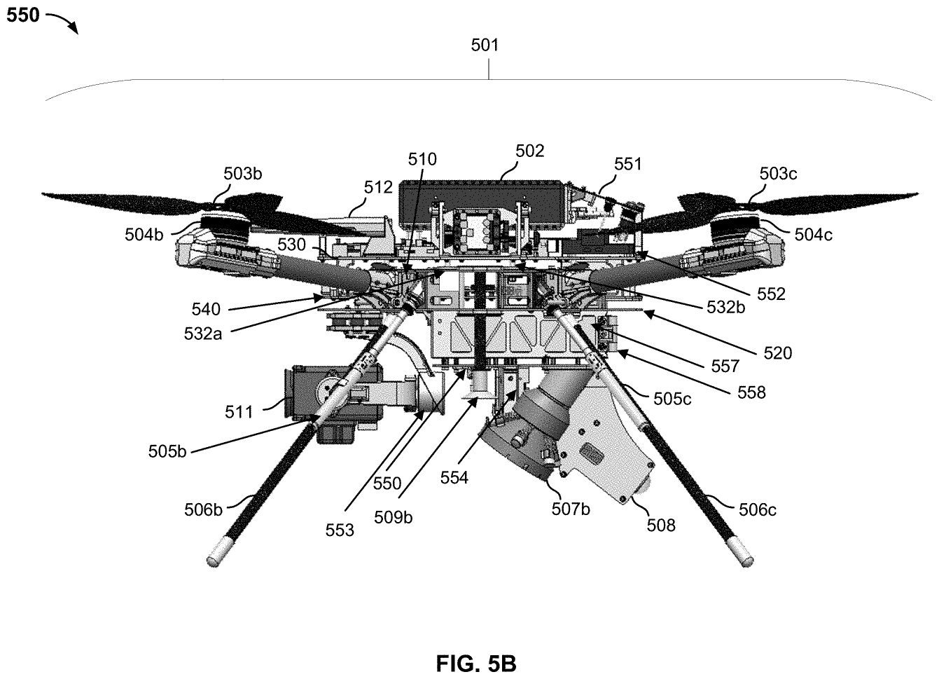

FIG. 5A is a diagram illustrating a front view of an unmanned aerial vehicle in accordance with some embodiments. In the example shown, front view 500 includes unmanned aerial vehicle 501 comprising computing chassis 502, first rotor 503a, second rotor 503b, first motor 504a, second motor 504b, first antenna 505a, second antenna 505b, first landing strut 506a, second landing strut 506b, first net launcher 507a, second net launcher 507b, first guide collar 509a, second guide collar 509b, interdiction sensor module 508, first structural isolation plate 510, visual detection system 511, disruption signal antenna 512, antenna clip 513, one or more cooling fans 514, first rotor arm bracket 515a, second rotor arm bracket 515b, first rotor arm 516a, second rotor arm 516b, second structural isolation plate 520, vibration isolation plate 530, vibration isolation plate 540, vibration isolation plate 550, and dampers 551.

Computing chassis 502 is configured to protect the CPU of UAV 501. The CPU is configured to control the overall operation of the UAV. The CPU may be coupled to a plurality of computing modules. For example, the plurality of computing modules may include an interdiction control module, an image processing module, a safety module, a flight recorder, etc. The CPU may provide one or more control signals to each of the plurality of computing modules. For example, the CPU may provide a control signal to the interdiction control module to activate one of the net launchers 507a, 507b to deploy a net. The CPU may provide a control signal to the image processing module to process an image captured by the visual detection system 511. The CPU may be configured to perform one or more flight decisions for the UAV. For example, the CPU may provide one or more flights commands to a flight controller. For example, a flight command may include a specified speed for the UAV, a specified flight height for the UAV, a particular flight path for the UAV, etc. In response to the one or more flight commands, the flight controller is configured to control the motors associated with the UAV (e.g., motors 504a, 504b) so that UAV 101 flies in a manner that is consistent with the flight commands. In some embodiments, the CPU is configured to receive flight instructions from a remote command center. In other embodiments, the CPU is configured to autonomously fly UAV 501.

The interdiction control module may be configured to monitor signals received from interdiction sensor module 508 and determine whether to activate first net launcher 507a or second net launcher 507a based on the signals. The interdiction control module may be configured to automatically activate a net launcher to deploy a capture net when a set of predefined firing conditions are met. In other embodiments, the interdiction control module may receive a command from the CPU indicating when to deploy a capture net. The set of predefined firing conditions may include an object being identified as a UAV, the identified UAV being within a threshold range from UAV 501, and the identified UAV having an associated flight pattern (e.g., hovering flight pattern).

The safety module is configured to interface with a user interface panel (not shown) of UAV 501. The safety module is configured to arm/disarm UAV 501. For example, the user interface panel may receive from an operator an input indicating that first net launcher 507a and second net launcher 507b should be disarmed to allow the operator to inspect and/or perform maintenance on UAV 501. In response to receiving the input, the safety module is configured to disarm first net launcher 507a and second net launcher 507b.

The image processing module is configured to process images acquired by visual detection system 511. The image processing module may be configured to determine whether a visually detected object is a UAV based on the visual data associated with the detected object. The image processing module may include a plurality of machine learning models that are trained to label a detected object based on the visual data. For example, the image processing module may include a first machine learning model that is configured to label objects as a UAV, a second machine learning model that is configured to label objects as a bird, a third machine learning model that is configured to label objects as a plane, etc.

The flight recorder module is an electronic recorded device that is configured to record specific UAV performance parameters. The flight recorder module may be coupled to the CPU of computing chassis 502 and visual detection system 511. The flight recorder module may be configured to record the CPU output in parallel with the image data associated with visual detection system 511. This allows the decisions made by the CPU based on the image data to be reviewed at a later time.

First structural isolation plate 510 is configured to isolate computing chassis 502 and its associated computing components from one or more noisy components. First structural isolation plate 510 is also configured to isolate the one or more noisy components from the electromagnetic interference noise associated with the computing components of computing chassis 502. The one or more noisy components isolated from computing chassis 502 and its associated computing components by first structural isolation plate 510 may include may include a communications radio (not shown in the front view) and a communications disruption signal generator (not shown in the front view).

First structural isolation plate 510 may include a foil made from a particular material (e.g., copper) and the foil may have a particular thickness (e.g., 0.1 mm). First structural isolation plate 510 may act as a structural component for UAV 501. First structural isolation plate 510 may be attached to a plurality of rotor arm brackets (e.g., rotor arm brackets 515a, 515b) and one or more rotor arm clips (not shown in the front view). The rotor arm brackets are coupled to a corresponding rotor arm. The one or more rotor arm clips are configured to lock and unlock corresponding rotor arms of UAV 501. The one or more rotor arm clips are configured to lock the rotor arms in a flight position when UAV 501 is flying. The one or more rotor arm clips are configured to unlock the rotor arms from a flight position when UAV 501 is not flying. For example, the rotor arms may be unlocked from the rotor arm clips when UAV 501 being stored or transported to different locations.

First structural isolation plate 510 is coupled to vibration isolation plate 530 via a plurality of vibration dampers. First structural isolation plate 510 may be coupled to one or more dampers configured to reduce the amount of vibration to which a plurality of vibration sensitive components are subjected. The plurality of vibration sensitive components may include the computing modules included in computing chassis 502, connectors, and heat sinks. The performance of the vibration sensitive components may degrade when subjected to vibrations. The one or more dampers may be omnidirectional dampers. The one or more dampers may be tuned to the specific frequency associated with a vibration source. The vibrations may be mechanical vibrations caused by the motors of the UAV (e.g., motors 504a, 504b) and the rotors of the UAV (e.g., rotors 503a, 503b). First structural isolation plate 510 in combination with vibration isolation plate 530 and the plurality of dampers are configured to shield the plurality of computing components from vibrations, noise, and EMI.

Vibration isolation plate 530 is coupled to antenna 512 associated with a communications disruption signal generator. Antenna 512 may be a highly directional antenna (e.g., parabolic, helical, yagi, phased array, horn, etc.) that is configured to transmit a communications disruption signal. The communications disruption signal may have a frequency associated with one or more wireless communications devices that the communications disruption signal is attempting to disrupt. For example, the communications disruption signal may have a frequency between 400 MHz and 10 GHz. In some embodiments, antenna 512 is coupled to a software defined radio, which is configured to generate the communications disruption signal

UAV 501 includes second structural isolation plate 520. A UAV may also be designed to include an isolation plate to isolate the noisy components from the radiating components and vice versa. Second structural isolation plate 520 is configured to isolate the one or more noisy components from one or more antennas and one or more sensors and vice versa. Second structural isolation plate 520 is also configured to act as a ground plane for the one or more antennas associated with a radio communications system of UAV 501.

Structural isolation plate 520 may also be coupled to one or more dampers to reduce an amount of vibration to which the noisy components are subjected. The combination of structural isolation plate 510 and structural isolation plate 520 act as a Faraday cage for the noisy components. The combination of structural isolation plate 510 and structural isolation plate 520 are configured to isolate one or more high noise generating components of the UAV from the other components of the UAV. For example, a radio communications system and a communication disruption signal generator may be isolated from a plurality of computing components and a plurality of antennas. As a result, the influence that vibrations, noise, and EMI have on the overall performance of the UAV is reduced. One or more cooling fans 514 may be positioned in between vibration isolation plate 530 and vibration isolation plate 540. The high noise generating components of the UAV may generate a lot of heat during operation. One or more cooling fans 514 are configured to direct air towards the high noise generating components such that a temperature of the high noise generating components of the UAV is reduced during operation. A portion of the one or more cooling fans 114 may be placed adjacent to one of the openings of the structural frame comprising first structural isolation plate 510 and second structural isolation plate 520.

First rotor arm bracket 515a is coupled to first rotor arm 516a and second rotor arm bracket 516a is coupled to second rotor arm 516b. First rotor arm 516a is coupled to motor 504a and rotor 503a. Second rotor arm 516b is coupled to motor 504b and rotor 503b. Rotor arm brackets 515a, 515b are configured to engage rotor arms 516a, 516b, respectively. UAV 501 may lift off from a launch location and fly when rotor arms 516a, 516b are engaged with their corresponding rotor arm brackets 515a, 515b. When rotor arms 516a, 516b are engaged with their corresponding rotor arm brackets 515a, 515b, motors 504a, 504b may provide a control signal to rotors 503a, 503b to rotate.

A radio communications system of UAV 501 may be associated with a plurality of antennas (e.g., antenna 505a, antenna 505b). Each antenna may operate at a different frequency. This enables the radio communications system to switch between frequency channels to communicate. The radio communications system may communicate with a remote server via antenna 505a. For example, the radio communications system may transmit the data associated with the one or more sensors associated with UAV 501 (e.g., radar data, lidar data, sonar data, image data, etc.). The frequency channel associated with antenna 505a may become noisy. In response to the frequency channel associated with antenna 505a becoming noisy, the radio communications system may switch to a frequency channel associated with antenna 505b. The antennas associated with the radio communications system may be daisy chained together. The persistent systems radio may communicate with one or more other UAVs and transmit via antennas 505a, 505b, a signal back to a source through the one or more other UAVs. For example, another UAV may act as an intermediary between UAV 501 and a remote server. UAV 501 may be out of range from the remote server to communicate using antennas 505a, 505b, but another UAV may in range to communicate with UAV 501 and in range to communicate with the remote sever. UAV 501 may transmit the data associated with one or more sensors to the other UAV, which may forward the data associated with one or more sensors to the remote server.

The radio communications system of UAV 501 may be associated with three antennas (e.g., antenna 505a, antenna 505b, antenna 505c). The antennas may be approximately 90 degrees apart from each other (e.g., 90°±5°). The antennas may coupled to the landing struts of UAV 501 (e.g., landing strut 506a, landing strut 506b, landing strut 506c) via an antenna clip, such as antenna clip 513. This allows the antennas to have a tripod configuration, which allows the antennas to have enough fidelity to transmit the needed bandwidth of data. For example, the tripod configuration allows the antennas to have sufficient bandwidth to transmit video data or any other data obtained from the one or more sensors of UAV 501.

UAV 501 may include a fourth antenna (not shown) that is also coupled to one of the landing struts of UAV 501. UAV 501 may be remotely controlled and the fourth antenna may be used for remote control communications. In some embodiments, the antennas coupled to the landing struts of UAV 501 may be integrated into the landing strut, such that an antenna is embedded within a landing strut.

UAV 501 may include guide collars 509a, 509b. Guide collars 509a, 509b may be coupled to a plurality of launch rails. UAV 501 may be stored in a hangar that includes the plurality of launch rails. Guide collars 509a, 509b are hollow and may be configured to slide along the launch rails to constrain lateral movement of UAV 501 until it has exited the housing or hangar.

UAV 101 may include a vibration plate 150 that is coupled to a battery cage via a plurality of dampers 151. The vibration plate 150 may be coupled to net launchers 507a, 507b and interdiction sensor system 508. Interdiction sensor system 508 may include at least one of a global positioning system, a radio detection and ranging (RADAR) system, a light detection and ranging (LIDAR) system, a sounded navigation and ranging (SONAR) system, an image detection system (e.g., photo capture, video capture, UV capture, IR capture, etc.), sound detectors, one or more rangefinders, etc. For example, eight LIDAR or RADAR beams may be used in the rangefinder to detect proximity to the target UAV. Interdiction sensor system 508 may include one or more LEDs that indicate to bystanders whether UAV 501 is armed and/or has detected a target. The one or more LEDs may be facing away from the back of UAV 501 and below UAV 501. This enables one or more bystanders under UAV 501 to become aware of a status associated with UAV 501.

Interdiction sensor system 508 may include image capture sensors which may be controlled by the interdiction control module to capture images of the object when detected by the range finding sensors. Based on the captured image and the range readings from the ranging sensors, the interdiction control module may identify whether or not the object is a UAV and whether the UAV is a UAV detected by one of the sensor systems.

When the interdiction control module determines that the object is a target UAV, it may also determine if the target UAV is an optimal capture position relative to the defending UAV. The position between UAV 501 and the target UAV may be determined based on one or more measurements performed by interdiction sensor system 508. If the relative position between the target UAV and the defending UAV is not optimal, interdiction control module may provide a recommendation or indication to the remote controller of the UAV. An interdiction control module may provide or suggest course corrections directly to the flight controller to maneuver UAV 501 into an ideal interception position autonomously or semi-autonomously. Once the ideal relative position between the target UAV and the defending UAV is achieved, the interdiction control module may automatically trigger one of the net launchers 507a, 507b. Once triggered, one of the net launchers 507a, 507b may fire a net designed to ensnare the target UAV and disable its further flight.

The net fired by the capture net launcher may include a tether connected to UAV 501 to allow UAV 501 to move the target UAV to a safe area for further investigation and/or neutralization. The tether may be connected to the defending UAV by a retractable servo controlled by the interdiction control module such that the tether may be released based on a control signal from the interdiction control module. The CPU of the UAV may be configured to sense the weight, mass, or inertia effect of a target UAV being tethered in the capture net and recommend action to prevent the tethered target UAV from causing UAV 501 to crash or lose maneuverability. For example, the CPU may recommend UAV 501 to land, release the tether, or increase thrust. The CPU may provide a control signal to allow the UAV to autonomously or semi-autonomously take corrective actions, such as initiating an autonomous or semi-autonomous landing, increasing thrust to maintain altitude, or releasing the tether to jettison the target UAV in order to prevent the defending UAV from crashing.

Net launchers 507a, 507b may include a corresponding net launcher head and a corresponding net launcher support bracket. The net launcher head may include one or more net launcher mounting points extending orthogonally from an upper surface of the net launcher head and configured to be inserted into a net launcher mounting point receiving notch formed on an interior surface of the net launcher support bracket. In some embodiments, this notch in the net launcher support bracket may be shaped such that the net launcher head may be inserted into the net launcher supporting bracket a predefined distance, and then rotated relative to the net launcher mounting bracket to lock the net launcher head into place. In some embodiments, the net launcher mounting point receiving not may be angled back towards the net launcher head along such that the net launcher moves outward slightly as it is rotated. In some embodiments, a compressible O-ring may be positioned between the net launcher head and the net launcher support bracket to provide a positive lock when the net launcher is rotated to the end of the net launcher mounting point receiving notch.

The net launcher head may also include a series of launch tubes equally spaced around the perimeter of the net launcher of the net launcher head. In some embodiments, the launch tubes include six carbon fiber tubes equally spaced around the perimeter of the net launcher head, each launch tube being covered by a removable end cover. Each of the launch tubes may be inserted into the net launch head to join at a shared gas expansion chamber. Within the gas expansion chamber, the gas direction point or protrusion may be provided to direct gas down the plurality of launch tubes an equal and efficient manner.

The gas direction point or protrusion may be aligned with the end of the gas charge (e.g., a micro gas generator (MGG) or other miniature gas producing device) which will provide the propulsive force to launch the net. In some embodiments, the gas charge may be a type of MGG that is used in an automatic seatbelt, which is triggered during a traffic accident. In other embodiments, the gas charge may be the type of gas charge typically used in air safety bag inflators. The gas charge may be inserted into a gas charge receiving tube located at the end of the net launcher head. The gas charge receiving tube may be a carbon fiber tube inserted into the end of the net launcher head to reinforce the net launcher head and prevent explosive failure when the gas charge is initiated via an application of an electric signal to the contacts located at the end of the gas charge. In order to hold the gas charge in the gas charge receiving tube, a gas charge retaining plate may be attached to the end of the net launcher head. Once the launch tubes have been inserted into the shared gas expansion chamber, the launch tubes may be expoxied into place using an epoxy resin or other material that may hold the launch tubes in place.

The net launcher head may also include a net cone having a plurality of launch tube retaining flanges into which each launch tube may be inserted and epoxied. The net cone may define an interior volume into which a net may be inserted and stored. The net come may be sealed with a cover providing moderate friction fit. In some embodiments, the cover is formed from a corrugated material such as a corrugated plastic providing a lightweight construction that can still maintain enough rigidity to hold the cover in place against the weight of the net. The net may be a square net attached by net lines to six weights which are slowed into the respective launch tubes of the launch head. In some embodiments, the weights may be metal weights such as steel iron copper brass or any other weight that may be apparent to a person of ordinary skill in the art.

A net line notch may be adjacent to each of the launch tubes to allow the net line attached to each weight to be inserted therein to the net line can pass through the sidewall of the net cone underneath the cover. The net line notch may be sized to be big enough to not restrict or reduce the launch velocity of the weights when the net launcher is fired, but small enough to not compromise the strength of the net cone. Further, a larger tether notch may also be provided in the side of the net cone to allow the tether of the net to be attached to a tether mechanism of an interdiction module when the interdiction module is mounted on a UAV, such as UAV 101 or UAV 501. As the tether line may be of larger diameter than the net lines attached to the weights, the size of the tether notch may be larger.

A plastic spacer may be provided on each net line to hold the weight at the opposite end of the launch tube from the net line notches. By holding each weight at the end of the launch tube closest to the shared gas expansion chamber, the acceleration distance of each weight within the launch tube may be maximized to improve launch velocity of the weights when discharged by the net launcher.

In some embodiments, a frangible cover may cover may surround the net cone and launch tubes to provide a waterproof seal for the net launcher head by sealing the tether notch and net line notches. The material for the frangible waterproof seal may be thin to prevent impeding launch velocity when the net launcher is fired.

UAV 501 may include visual detection system 511. Visual detection system 511 may include one or more cameras. Visual detection system 511 may be used by a remote operator to control a flight path associated with UAV 501. Visual detection system 511 may provide visual data to an image processing module configured to visually detect an object and provide visual data (e.g., pixel data) to one or more machine learning models. The one or more machine learning models may be trained to label an object as a UAV based on the visual data. The image processing module may provide an output indicating that an object is labeled as a UAV to the interdiction control module. The interdiction control module may be configured to activate net launchers 507a, 507b based on the label. For example, in the event the visually detected object is labeled a UAV and the visually detected object is within a threshold range from UAV 501, the interdiction control module may output a control signal that causes one of the net launchers 507a, 507b to deploy a net.

FIG. 5B is a diagram illustrating a side view of an unmanned aerial vehicle in accordance with some embodiments. In the example shown, side view 500 includes unmanned aerial vehicle 501 comprising computing chassis 502, UI panel 551, flight controller module 552, second rotor 503b, third rotor 503c, second motor 504b, third motor 504c, second antenna 505b, third antenna 505c, second landing strut 506b, third landing strut 506c, battery 557, battery cage 558, second net launcher 507b, interdiction sensor module 508, second guide collar 509b, first structural isolation plate 510, visual detection system 511, disruption signal antenna 512, antenna clip 513, second structural isolation plate 520, gimbal 553, tether mechanism 554, vibration dampers 532a, 532b, vibration isolation plate 530, vibration isolation plate 540, and vibration isolation plate 550.

UI panel 551 is coupled a safety module that is included in computing chassis 502. UI panel 551 comprises one or more switches, knobs, buttons that enables an operator to arm and disarm UAV 501. An operator may interact with UI panel 551 and based on the operator interactions, the safety module is configured to arm/disarm UAV 501. For example, first net launcher 507a and second net launcher 507b may be disarmed based on one or more interactions of an operator with UI panel 551. This may allow the operator to inspect and/or perform maintenance on UAV 501.

Flight controller module 552 is configured to control a flight of UAV 501. The flight controller module may provide one or more control signals to the one or more motors (e.g., 504a, 504b) associated with UAV 501. The one or more control signals may cause a motor to increase or decrease its associated revolutions per minute (RPM). UAV 501 may be remotely controlled from a remote location. UAV 501 may include an antenna that receives flight control signals from the remote location. In response to receiving the flight control signals, the CPU of UAV 501 may determine how UAV 501 should fly and provide control signals to flight controller module 552. In response to the control signals, flight controller module 552 is configured to provide control signals to the one or more motors associated with UAV 501, causing UAV 501 to maneuver as desired by an operator at the remote location.

Antenna 505c is coupled to landing strut 506c. Antenna 505c is one of the antennas associated with a communications radio system of UAV 501. Antenna 505c is configured to operate at a frequency that is different than antennas 505a, 505b. A communications radio system may be configured to switch between frequency channels to communicate. The communications radio system may communicate with a remote server via antenna 505a. The frequency channel associated with antenna 505a may become noisy. For example, the radio communications system may transmit the data associated with the one or more sensors associated with UAV 501 (e.g., radar data, lidar data, sonar data, image data, etc.). In response to the frequency channel associated with antenna 505a becoming noisy, the radio communications system may switch to a frequency channel associated with antenna 505b. The frequency channel associated with antenna 505b may become noisy. In response to the frequency channel associated with antenna 505b becoming noisy, the radio communications system may switch to a frequency channel associated with antenna 505c.

Battery 557 is configured to provide power to UAV 501. UAV 501 is comprised of a plurality of components that require electricity to operate. Battery 557 is configured to provide power to the plurality of components. In some embodiments, battery 557 is a rechargeable battery. Battery 557 is housed within battery cage 558. Battery cage 558 may be coupled to vibration isolation plate 550 via a plurality of dampers. Vibration isolation plate 550 may be coupled to interdiction sensor module 508, net launchers 507a, 507b, tether mechanism 525, and a persistent availability plug.

Gimbal 553 is coupled to visual detection system 511 and second structural isolation plate 520. A gimbal is a pivoted support that allows the rotation of visual detection system 511 about a single axis. Gimbal 553 is configured to stabilize an image captured by visual detection system 511.

Tether mechanism 554 is coupled to net capture launchers 507a, 507b. When a net is deployed by one of the net capture launchers 507a, 507b, the net remains tethered to UAV 501 via tether mechanism 525. Tether mechanism 525 may be configured to sense the weight, mass, or inertia effect of a target UAV being tethered in the capture net. In response to the sensed signals, a CPU of UAV 501 may be configured to recommend action to prevent the tethered target UAV from causing UAV 501 to crash or lose maneuverability. For example, the CPU of UAV 501 may recommend UAV 501 to land, release the tether, or increase thrust. The CPU of UAV 501 may provide a control signal to allow the UAV to autonomously or semi-autonomously take corrective actions, such as initiating an autonomous or semi-autonomous landing, increasing thrust to maintain altitude, or releasing the tether to jettison the target UAV in order to prevent the defending UAV from crashing.

Vibration dampers 532a, 532b are coupled to structural isolation plate 510 and vibration isolation plate 530. Vibration dampers 532a, 532b may be omnidirectional dampers. Vibration dampers 532a, 532b may be configured to reduce the amount of vibration to which a plurality of vibration sensitive components are subjected. The plurality of vibration sensitive components may include different electronics modules (e.g., components included in computing chassis 502, connectors, and heat sinks. The performance of the vibration sensitive components may degrade when subjected to vibrations. Vibration dampers 532a, 532b may be tuned to the specific frequency associated with a vibration source. The vibrations may be mechanical vibrations caused by the motors of the UAV (e.g., motors 504a, 504b) and the rotors of the UAV (e.g., rotors 503a, 503b, 503c). Vibration dampers 532a, 532b may be tuned to the mechanical vibrations caused by the motors of the UAV and the rotors of the UAV. Vibration dampers 532a, 532b may be comprised of a vibration damping material, such as carbon fiber. In some embodiments, one or more vibration dampers may be included in between a motor and a motor mount.

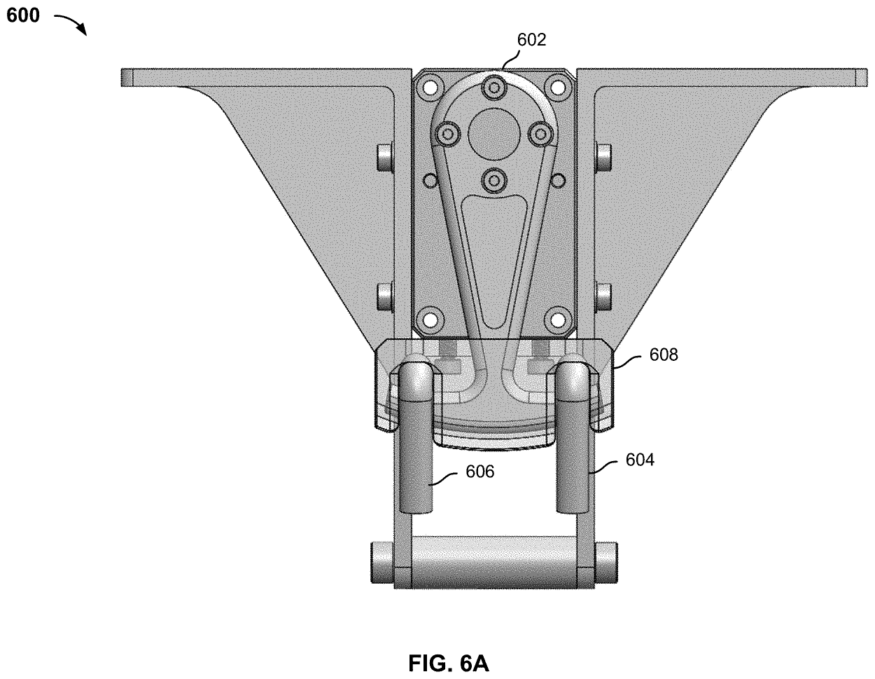

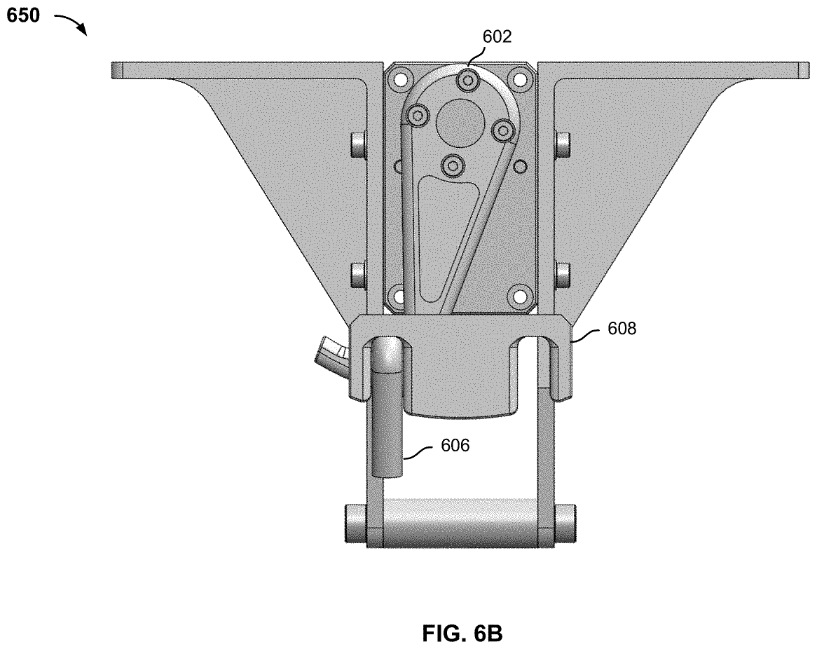

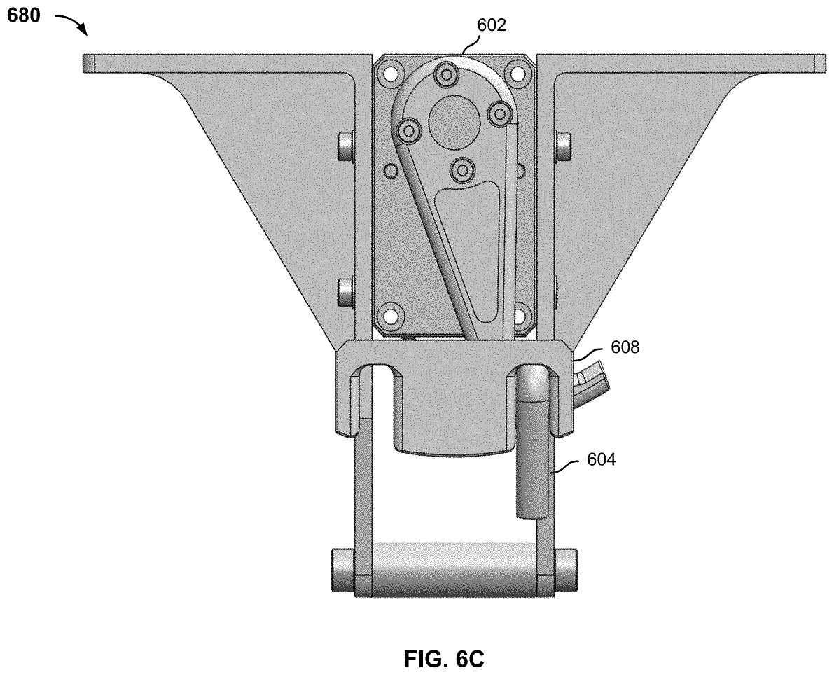

FIG. 6A is a diagram illustrating an embodiment of a tether mechanism. In the example shown, tether mechanism 600 may be in a UAV, such as tether mechanism 554 in UAV 501 or tether mechanism 112 in UAV 101.

In the example shown, tether mechanism 600 includes a locking mechanism 602 and a lock plate 608. Tether mechanism 600 is configured to be tether to two nets. In the example shown, tether mechanism 600 is configured to be tethered to a first tether 604 associated with a first net capture launcher, such as first net capture launcher 507a, and a second tether 606 associated with a second net capture launcher, such as second net capture launcher 507b. Locking mechanism 602 has an anchor portion that weaves through a loop of first tether 604 and a loop of second tether 606. Lock plate 608 is shown to be transparent for illustrative purposes. Lock plate 608 has a first inlet portion for the first tether 604 and a second inlet portion for the second tether 606. When the first tether 604 is positioned in the first inlet portion and the second tether 606 is positioned in the second inlet portion, the anchor mechanism of locking mechanism 602 is coupled to the first net capture launcher 507a and the second net capture launcher 507b.

In the example shown, lock mechanism 602 is shown in a neutral position. Lock mechanism 602 is configured to remain in the neutral position until a net tethered by first tether 604 or a net tethered by second tether 606 is to be dropped from a UAV. When a net is deployed from a net capture launcher, the net remains tethered to the UAV by a loop of the tether, such as a loop of first tether 604 or a loop of second tether 606.

A motor (not shown) associated with tether mechanism may adjust a position of lock mechanism. The motor may be a position motor, servo motor, motor with position feedback/control, etc. When the motor receives a command to move lock mechanism 602 is a particular position, the motor may apply a current to move lock mechanism 602 to the particular position. The motor may also apply a current to maintain lock mechanism 602 in the particular position. If an external force pushes against the servomotor while the servomotor is maintaining lock mechanism 602 in the neutral position, the servomotor is configured to resist from moving out of the neutral position by applying a current to the motor. The amount of current applied is proportional to the amount of force required to counter act the external force trying to move the motor out of position.

In some embodiments, lock mechanism 602 is in a neutral position when a net has not been deployed by one of the net capture launchers 507a, 507b. The servo motor may maintain the neutral position of lock mechanism 602 without having to apply a current or applying a nominal current.

In some embodiments, lock mechanism 602 is in the neutral position when one of the nets has been deployed by one of the net capture launchers 507a, 507b. In the event the net was snagged, the servo motor is configured to apply a first amount of current to maintain lock mechanism 602 in the neutral position. The net is determined to be snagged in the event the first amount of current is less than a first current threshold. In the event the net was deployed and did not capture a target UAV, the server motor is configured to apply a second amount of current to maintain lock mechanism 602 in the neutral position. The net is determined to be deployed and not capture a target UAV in the event the second amount of current is greater than the first current threshold, but less than a second current threshold. In the event the net has captured a target UAV, the servo motor is configured to apply a third amount of current to maintain lock mechanism 602 in the neutral position. The net is determined to be deployed and captured a target UAV in the event the third amount of current is greater than the first current threshold and the second current threshold. The current profiles associated with the first amount of current, the second amount of current, and the third amount of current are different. The current profiles may be used to determine whether a target UAV was successfully captured. In the event a target UAV was successfully captured, a transmission of a communication disruption signal may be stopped.

FIG. 6B is a diagram illustrating an embodiment of a tether mechanism. In the example shown, tether mechanism 650 is shown in a release state. A current may applied by a servo motor to lock mechanism 602 to release one of the nets. In the example shown, a current was applied to lock mechanism 602 to release first tether 604. A current may be applied by a servo motor to move lock mechanism 602 to the release state when a captured UAV has been brought to a safe place. A current may be applied by a servo motor to move lock mechanism 602 to the release state when a captured UAV is being tethered to a defending UAV and causing the defending UAV to fly in an unstable state (e.g., the defending UAV may crash due to be tethered to the captured UAV).

FIG. 6C is a diagram illustrating an embodiment of a tether mechanism. In the example shown, tether mechanism 680 is shown in a release state. A current may applied by a servo motor to lock mechanism 602 to release one of the nets. In the example shown, a current was applied to lock mechanism 602 to release second tether 606. A current may be applied by a servo motor to move lock mechanism 602 to the release state when a captured UAV has been brought to a safe place. A current may be applied by a servo motor to move lock mechanism 602 to the release state when a captured UAV is being tethered to a defending UAV and causing the defending UAV to fly in an unstable state (e.g., the defending UAV may crash due to be tethered to the captured UAV).

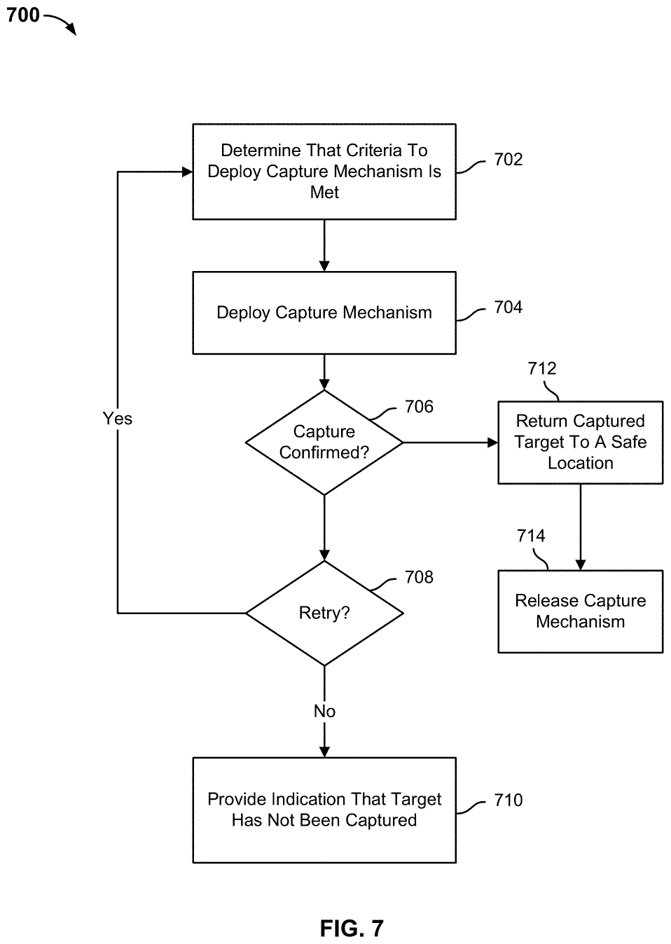

FIG. 7 is a flow chart illustrating an embodiment of a process for capturing a target object. In the example shown, process 700 may be performed by a UAV, such as UAV 100 or UAV 501. Process 700 may be implemented to perform some or all of step 308 of process 300.

At 702, it is determined that criteria to deploy a capture mechanism is met. The criteria include a target UAV being detected, the target UAV is within a threshold distance, and the target UAV is currently hovering over a particular area due to the communications system of the target UAV being blocked and/or interfered.

At 704, a capture mechanism is deployed. A UAV may include an interdiction system that enables the UAV to capture, disable, and/or transport a target UAV away from a particular area. The interdiction system may be comprised of a capture net launcher, an interdiction sensor package, and an interdiction control system. The interdiction control system may monitor signals received from the interdiction sensor package and control the capture net launcher to automatically deploy the capture net when the deploy criteria is met. A net may be ejected from one of the net capture launchers towards a target UAV. The net may remain tethered to the defending UAV via a tether (e.g., a rope, cable, etc.).

At 706, it is determined whether a capture is confirmed. In some embodiments, a capture is visually confirmed by a camera, such as a camera included in a visual detection system.

In other embodiments, a capture is confirmed based on a current profile of a motor associated with a tether mechanism. The tether mechanism may include a motor, such as servo motor, and a locking mechanism. The locking mechanism may be a neutral position and the servo motor is configured to maintain the locking mechanism in the neutral position. When a net has not been deployed, the servo motor may apply a nominal current to maintain the locking mechanism in the neutral position. When the net has been deployed, the servo motor may apply a current that is different from the nominal current to maintain the locking mechanism in the neutral position. The capture is confirmed in the event the current matches a current profile associated with a captured target.

In the event a capture is confirmed, process 700 proceeds to 712. In the event a capture is not confirmed, process 700 proceeds to 708.

At 708, is determined whether it is possible to attempt a retry of capturing the target. A UAV stores a finite number of capture mechanisms. In some embodiments, a UAV stores two capture mechanisms. It is determined whether the UAV has any capture mechanisms remaining to attempt a retry of capturing the target.

In the event it is possible to attempt a retry of capturing the target, i.e., the UAV includes unused capture mechanisms, process 700 returns to 702. In the event it is not possible to attempt a retry of capturing the target, i.e., the UAV does not include any unused capture mechanisms, process 700 proceeds to 710.

At 710, an indication that the target has not been captured is provided.

At 712, the capture target is returned to a safe location. When the capture mechanism is launched and captures a target UAV, the target UAV may remain tethered to the defending UAV via a tether (e.g., rope, cable, etc.). This enables the defending UAV to transport the target UAV to a safe location

At 714, the capture mechanism is released. A servo motor may apply a current to a locking mechanism associated with a tether mechanism. The current may move the locking mechanism from a neutral position to a release state. For example, the tether mechanism may be in a release state shown in either FIG. 6B or 6C. This enables the tether, capture mechanism, and captured target to be untethered from the defending UAV.

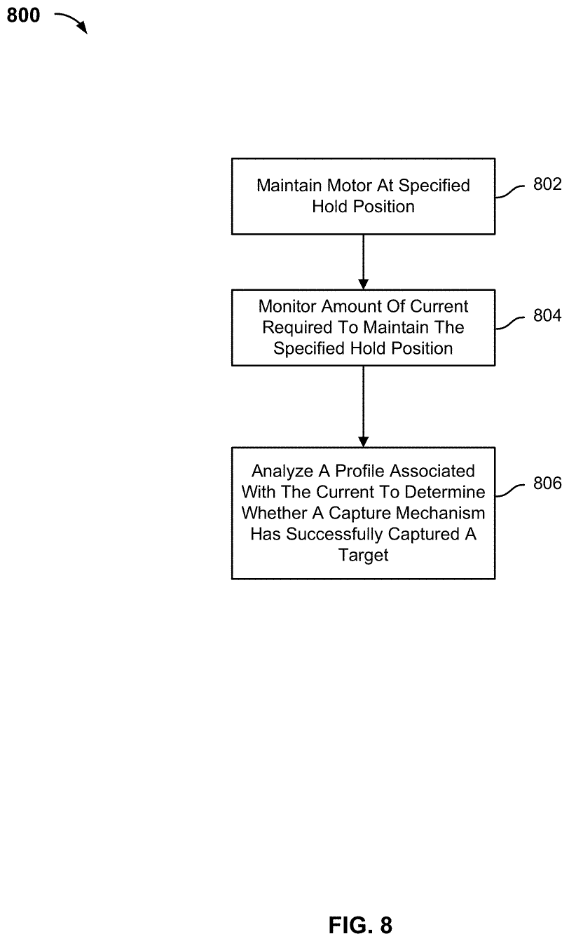

FIG. 8 is a flow chart illustrating an embodiment of a process for determining that a target object has been captured. In the example shown, process 800 may be performed by a UAV, such as UAV 100 or UAV 501. Process 800 may be implemented to perform some or all of step 706 of process 700.

At 802, a motor at a specified hold position is maintained. A motor associated with a tether mechanism is configured to apply a current to a lock mechanism of the tether mechanism. The motor associated with the tether mechanism may be a position motor, a motor with position feedback/control, servo motor, etc. When a servo motor is commanded to move, the servo motor is configured to move to the position and maintain that position. The lock mechanism may include a neutral position and a release position. In response to a command to move to a neutral position, the servo motor is configured to apply a current to the lock mechanism to move the lock mechanism to the neutral position and to apply a current to the lock mechanism to maintain the neutral position. In response to a command to move to a release position, the servo motor is configured to apply a current to the lock mechanism to move the lock mechanism to the release position and to apply a current to the lock mechanism to maintain the release position.

If an external force pushes against the servo motor while the servo motor is holding a position, the servo motor is configured to resist from moving out of that position by applying a current to the motor. The amount of current applied is proportional to the amount of force required to counter act the external force trying to move the motor out of position.

A tether mechanism may be configured to be tethered to a first tether associated with a first net capture launcher and a second tether associated with a second net capture launcher. The locking mechanism of the tether mechanism includes an anchor portion that weaves through a loop of first tether and a loop of second tether when the locking mechanism is in the neutral position.

At 804, an amount of current required to maintain the specified hold position is monitored. A nominal current is applied by the servo motor to maintain the neutral position when the lock mechanism is in the neutral position and a net of one of the net capture launchers has not been deployed. When one of the nets of the net capture launchers is deployed, the net remains tethered to the tether mechanism via the tether. In the event the net was deployed and did not capture a target, an external force will be applied to the servomotor, i.e., due to the net dangling through air. In this instance, the servomotor will apply a first current to maintain the neutral position. In the event the net was deployed and did capture a target, an external force will be applied to the servomotor, i.e., due to the weight of the target and/or any resistance from the target. In this instance, the servomotor will apply a second current to maintain the neutral position. The second current exceeds a second current threshold.

At 806, a profile associated with the current is analyzed to determine whether a capture mechanism has successfully captured a target. In the event the applied current does not exceeds a first threshold, the capture mechanism is determined to have not been activated. This may indicate a snag with capture mechanism. In the event the applied current exceeds a first threshold, but does not exceed a second threshold, the capture mechanism is determined to have been activated, but did not successfully capture a target. In the event the applied current exceeds the first and second thresholds, the capture mechanism is determined to have been activated and successfully captured a target. The profile associated with the current may have a particular duration and/or frequency. The profile associated with the current when the capture mechanism is determined to have been activated, but did not successfully capture a target may have a first duration and/or a first frequency. The profile associated with the current when the capture mechanism is determined to have been activated and successfully captured a target may have a second duration and/or a second frequency.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An aerial vehicle system, comprising:
a detector configured to detect a presence of a target unmanned aerial vehicle within a range of the aerial vehicle system;
a signal generator configured to generate a communication disruption signal; and
a transmitter configured to trigger a transmission of the communication disruption signal based in part on the detected presence of the target unmanned aerial vehicle.

2. The aerial vehicle system of claim 1, wherein the communication disruption signal is based on a sawtooth wave.

3. The aerial vehicle system of claim 1, wherein the communication disruption signal is configured to disrupt communications in a frequency range of 2.1 GHz to 5.8 GHz.

4. The aerial vehicle system of claim 1, wherein the detector is configured to determine a type of the target unmanned aerial vehicle.

5. The aerial vehicle system of claim 4, wherein a power of the communication disruption signal is based on the type of the target unmanned aerial vehicle.

6. The aerial vehicle system of claim 1, wherein a power of the communication disruption signal is based on a distance between the target unmanned aerial vehicle and the aerial vehicle system.

7. The aerial vehicle system of claim 1, further comprising:
a visual detector configured to monitor a flight pattern associated with the target unmanned aerial vehicle.

8. The aerial vehicle system of claim 7, wherein the signal generator is configured to increase a power of the communication disruption signal based on the flight pattern associated with the target unmanned aerial vehicle.

9. The aerial vehicle system of claim 1, further comprising an interdiction system configured to deploy one or more capture mechanisms to capture the target unmanned aerial vehicle.

10. The aerial vehicle system of claim 9, wherein the transmitter is configured to trigger a discontinue command to stop the transmission of the communication disruption signal in response to the one or more capture mechanisms being deployed.

11. The aerial vehicle system of claim 9, wherein the interdiction system comprises a tether mechanism.

12. The aerial vehicle system of claim 10, wherein an output from the tether mechanism is a current profile of a motor associated with the tether mechanism.

13. The aerial vehicle system of claim 11, wherein the motor associated with the tether mechanism is configured to output a current profile when a lock mechanism of the tether mechanism is in a neutral position.

14. The aerial vehicle system of claim 12, wherein the motor associated with the tether mechanism is configured to apply a current to the lock mechanism to maintain the neutral position.

15. The aerial vehicle system of claim 13, wherein the current profile of the motor associated with the tether mechanism has a first current profile in the event the lock mechanism is in the neutral position and the aerial vehicle system is not tethered to the target unmanned aerial vehicle.

16. The aerial vehicle system of claim 14, wherein the current profile of the motor associated with the tether mechanism has a second current profile in the event the lock mechanism is in the neutral position and the aerial vehicle system is tethered to the target unmanned aerial vehicle.

17. The aerial vehicle system of claim 15, wherein the transmitter is configured to trigger the discontinue command to stop the transmission of the communication disruption signal in the event the motor associated with the tether mechanism is outputting the second current profile.

18. The aerial vehicle system of claim 1, wherein the transmitter is configured to trigger the transmission of the communication disruption signal based in part on the target unmanned aerial vehicle being within a threshold range from the aerial vehicle system or the target unmanned aerial vehicle being classified as the target unmanned aerial vehicle.

19. A method, comprising:
detecting a presence of a target unmanned aerial vehicle within a range of the aerial vehicle system;
generating a communication disruption signal; and
triggering a transmission of the communication signal based on the detected presence of the target unmanned aerial vehicle.

20. A computer program product, the computer program product being embodied on a non-transitory computer readable storage medium and comprising instructions for:
detecting a presence of a target unmanned aerial vehicle within a range of the aerial vehicle system;
generating a communication disruption signal; and
triggering a transmission of the communication signal based on the detected presence of the target unmanned aerial vehicle.
